(19) United States
(12) Patent Application Publication
(10) Pub. No.: US 2015/0234134 A1
(43) Pub. Date: Aug. 20, 2015

(54) Optical Path Converting Optical Coupling Device Connected with Optical Fiber, and Optical Module

(71) Applicant: Hitachi, Ltd., Chiyoda-ku, Tokyo (JP)

(72) Inventors: Toshiki Sugawara, Tokyo (JP); Kenichi Tanaka, Tokyo (JP); Yasunobu Matsuoka, Tokyo (JP)

(21) Appl. No.: 14/422,816

(22) PCT Filed: Sep. 28, 2012
(86) PCT No.: PCT/JP2012/075165

§ 371 Date: Feb. 20, 2015

(51) Int. Cl. G02B 6/42

(52) U.S. Cl. CPC G02B 6/4214; G02B 6/4212

(57) ABSTRACT

Provided is an optical path converting optical coupling device for an optical fiber having a plurality of concentrically disposed cores. The optical path converting optical coupling device includes a plurality of first inclined mirror portions concentrically disposed corresponding to the positions of the plurality of cores. The plurality of the first inclined mirror portions reflect a plurality of optical signals emitted from the plurality of cores or becoming incident on the plurality of cores, in such a manner that optical paths of the plurality of optical signals do not intersect with each other.

### TECHNICAL FIELD

The present invention relates to an optical path converting optical coupling device connected with an optical fiber, and an optical module.

### BACKGROUND ART

As a result of the growth of broadband enabled by optical fiber communications, large capacity digital information can now be distributed inexpensively. New services utilizing the technology have further promoted the use of broadband, and the Internet traffic has been growing at the high rate of roughly doubling every two years. So far, optical fiber networks have been expanded in which large volumes of data are exchanged at high speed over relatively long distances of several kilometers or longer, for backbone, metro, and access networks. It is considered that in the future, optical interconnect technology for conversion of signal wiring to optical connection will be effective also for extremely near distances of information communication (ICT) devices, such as between devices (several to several hundred meters) or within a device (several to several dozen centimeters).

Meanwhile, for increasing capacity, research and development have been focused on expanding the communication capacity of optical fiber using wavelength multiplexing technology and multi-level modulation/demodulation technology. However, such technologies are nearing their physical limit. As a technology for breaking through the limit, an optical communication technology using multi-core fiber (MCF) is considered promising. In the conventional fiber, a single fiber has a transmission channel by only one core. On the other hand, a multi-core fiber has transmission channels by a plurality of cores in a single fiber. Thus, the technology is gaining interest as a transmission medium for enabling large-volume and high-density transmission.

As an application of such optical communication technology, there is a demand for achieving higher image resolution in consumer devices, such as video cameras and other video equipment, personal computers (PC), and portable telephones, in addition to social infrastructure systems. For example, an increase in picture signal transmission speed and capacity between a monitor and a terminal has been achieved, and optical conversion of signal transmission lines has been implemented. As a result of such increases in information capacity, there is a demand for optical communication technology capable of achieving size and cost reduction and of addressing increases in density and volume, and an optical device and module technology for implementing the optical communication technology, with a view to realizing optical interconnection of, or within, ICT devices, and of consumer devices.

In recent years, researches have been conducted on large capacity fibers using the multi-core fiber, and on optical devices and modules for realizing small-sized, high-density transmission. Patent Literature 1 discloses an optical device (optical chip) in which a grating coupler is laid out to match the arrangement of the MCF cores and is connected to a photo diode (PD) or a modulator via a waveguide.

### CITATION LIST

### Patent Literature

Patent Literature 1: JP 2012-514768 A

### SUMMARY OF INVENTION

### Technical Problem

In the conventional configuration, with regard to optical connection with an MCF, an optical device with a custom layout in accordance with the arrangement of the MCF cores is required. Currently, due to the demand for obtaining uniform intervals between a plurality of cores in view of the problem of crosstalk, MCF development is predominantly focused on seven cores and 19 cores geometrically. However, the core size and arrangement such as core-to-core pitch are being developed in accordance with an independent design of each institution, and there are no unified specifications and the like. Accordingly, a custom optical device layout is required for each type.

The present invention provides an optical path converting optical coupling device and an optical module that eliminate the need for a custom layout with respect to optical connection of an MCF of a general-purpose number of cores (such as seven or 19) and an optical device (such as one of linear array-type).

### Solution to Problem

In order to solve the problem, the configurations set forth in the claims are adopted, for example. While the present application includes a plurality of means for solving the problem, in one example, there is provided an optical path converting optical coupling device for an optical fiber having a plurality of concentrically disposed cores. The device includes a plurality of first inclined mirror portions concentrically disposed corresponding to the positions of the plurality of cores. The plurality of first inclined mirror portions reflect a plurality of optical signals emitted from the plurality of cores or becoming incident on the plurality of cores, in such a manner that optical paths of the plurality of optical signals do not intersect with each other.

In another example, there is provided an optical module including an optical fiber having a plurality of concentrically disposed cores; an optical path converting optical coupling device that converts optical paths of a plurality of optical signals emitted from the plurality of cores of the optical fiber or becoming incident on the plurality of cores; and an array optical element including a plurality of linearly disposed elements that receive the plurality of optical signals from the optical path converting optical coupling device or that emit the plurality of optical signals to the optical path converting optical coupling device. In the optical module, the optical path converting optical coupling device includes a plurality of first inclined mirror portions concentrically disposed corresponding to the positions of the plurality of cores, and the plurality of the first inclined mirror portions reflect the plurality of optical signals emitted from the plurality of cores or from the array optical element, in such a manner that the optical paths of the plurality of optical signals do not intersect with each other.

### Advantageous Effects of Invention

According to the present invention, the need for a custom layout with respect to optical connection of an MCF and an optical device is eliminated, and the optical connection can be easily realized.

Additional features of the present invention will become apparent from the following description in the present specification and the attached drawings. Other problems, configurations, and effects will become apparent from the following description of embodiments.

### BRIEF DESCRIPTION OF DRAWINGS

FIG. 1 illustrates an example of an optical module according to a first embodiment of the present invention.

FIG. 2 illustrates an example of an optical path conversion unit according to the first embodiment of the present invention.

FIG. 3 illustrates an example of a large capacity optical fiber according to the first embodiment of the present invention.

FIG. 4 illustrates an example of an array optical element unit according to the first embodiment of the present invention.

FIG. 5 illustrates another example of the optical path conversion unit according to the first embodiment of the present invention.

FIG. 6 is a top view of the optical module according to the first embodiment of the present invention.

FIG. 7A is a side view of the optical path conversion unit and the array optical element unit according to the first embodiment of the present invention.

FIG. 7B is a top view of the optical path conversion unit and the array optical element unit according to the first embodiment of the present invention.

FIG. 8A is a side view of the optical path conversion unit and the array optical element unit according to a second embodiment of the present invention.

FIG. 8B is a top view of the optical path conversion unit and the array optical element unit according to the second embodiment of the present invention.

FIG. 9 is a cross sectional view of a second optical path conversion unit.

FIG. 10 is a cross sectional view of another example of the second optical path conversion unit.

FIG. 11 illustrates an example of the optical module according to a third embodiment of the present invention, showing a top view of the optical module in a case where the number of cores is 19.

FIG. 12A is a side view of the optical path conversion unit and the array optical element unit according to a fourth embodiment of the present invention.

FIG. 12B is a top view of the optical path conversion unit and the array optical element unit according to the fourth embodiment of the present invention.

FIG. 13A is a side view of the optical path conversion unit and the array optical element unit according to a fifth embodiment of the present invention.

FIG. 13B is a top view of the optical path conversion unit and the array optical element unit according to the fifth embodiment of the present invention.

FIG. 14A is a side view of the optical path conversion unit and the array optical element unit according to a sixth embodiment of the present invention.

FIG. 14B is a top view of the optical path conversion unit and the array optical element unit according to the sixth embodiment of the present invention.

### DESCRIPTION OF EMBODIMENTS

In the following, embodiments of the present invention will be described with reference to the attached drawings. While the attached drawings indicate concrete embodiments in accordance with the principle of the present invention, the embodiments are for facilitating an understanding of the present invention and not to be taken for interpreting the present invention in a limited sense.

### First Embodiment

In the present embodiment, a description will be given of an example of an optical path converting optical coupling device for realizing optical connection of an optical fiber which is a multi-core fiber (MCF) and an array optical element of linear array-type. Further, in the present embodiment, a description will be given of an example of an optical module provided with the optical fiber, the array optical element, and the optical path converting optical coupling device.

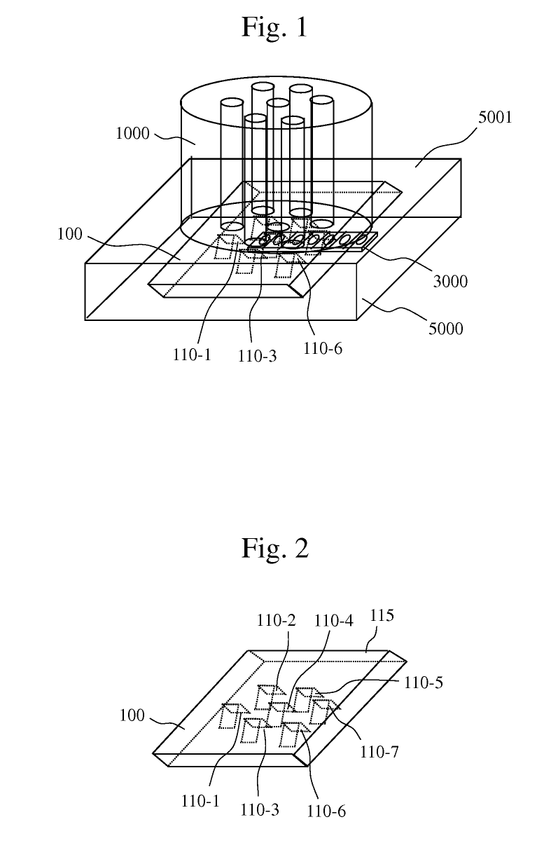

FIG. 1 illustrates an example of the optical module according to a first embodiment of the present invention. The optical module 5000 according to the present embodiment includes a large capacity optical fiber 1000 (hereafter simply referred to as an “optical fiber”), such as represented by a multi-core fiber; an optical path conversion unit (optical path converting optical coupling device) 100 disposed in the optical module 5000; and an array optical element unit (array optical element) 3000. The optical module 5000 is connected to the optical fiber 1000. In the present embodiment, the optical fiber 1000 is disposed on a plane surface 5001 of the optical module 5000. The optical path conversion unit 100 also includes a plurality of first inclined mirror portions 110-1, . . . , 110-7. Hereafter, the optical path conversion unit 100, the optical fiber 1000, and the array optical element unit 3000 will be described in detail with reference to FIGS. 2, 3, and 4.

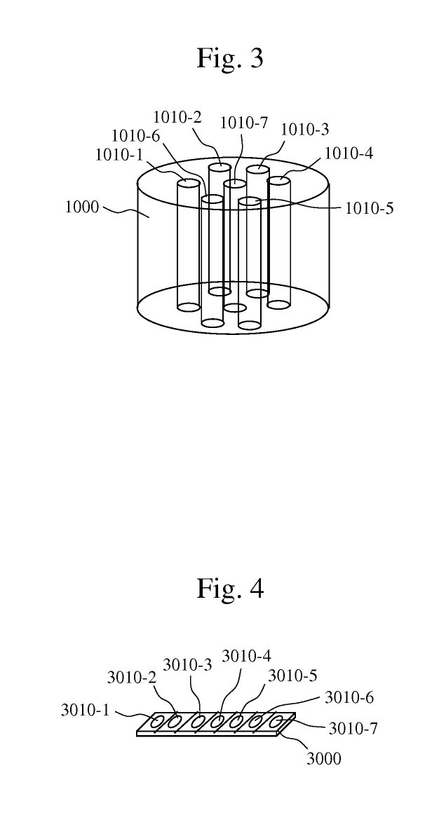

FIG. 2 illustrates an example of the first optical path conversion unit 100 according to the first embodiment of the present invention. In FIGS. 1 and 3, the optical fiber 1000 as a large capacity optical fiber includes seven core portions 1010-1, . . . , 1010-7 which are concentrically disposed. The optical path conversion unit 100 has a configuration corresponding to the core portions 1010-1, . . . , 1010-7 of the optical fiber 1000. As illustrated in FIG. 2, the optical path conversion unit 100 includes a plurality (seven) of first inclined mirror portions 110-1, . . . , 110-7 and a second inclined mirror portion 115. The plurality of first inclined mirror portions 110-1, . . . , 110-7 are concentrically disposed corresponding to the positions of the plurality of core portions 1010-1, . . . , 1010-7.

Preferably, for the optical path conversion unit 100, a material with good transmissivity with respect to the wavelength of the light utilized for optical communication is used. For example, when the wavelength is 1.3 μm to 1.5 μm, the optical path conversion unit 100 is realized using glass, resin, semiconductor such as Si, or organic material. When the wavelength is 0.85 μm, the optical path conversion unit 100 may be realized using glass, resin, or organic material.

In FIG. 2, the plurality of first inclined mirror portions 110-1, . . . , 110-7 of the optical path conversion unit 100 are fabricated from V-shaped groove shaped portions. In this example, in the optical path conversion unit 100, the V-shaped groove shaped portions are concentrically formed corresponding to the positions of the plurality of core portions 1010-1, . . . , 1010-7. Here, of the two faces forming each of the V-shaped groove shaped portions, one face provides a reflective face. By the reflective faces of the V-shaped groove shaped portions of the first inclined mirror portions 110-1, . . . , 110-7, a plurality of optical signals are reflected. The second inclined mirror portion 115 is formed on a face of the optical path conversion unit 100 corresponding to the optical paths of the optical signals reflected by the first inclined mirror portions 110-1, . . . , 110-7 (or of the optical signals reflected toward the first inclined mirror portions 110-1, . . . , 110-7). In the present embodiment, the first inclined mirror portions 110-1, . . . , 110-7 reflect the plurality of optical signals at the same height position and in such a manner that the optical paths of the plurality of optical signals become parallel with each other. Thus, the second inclined mirror portion 115 is formed as a single reflective face. As will be described below, the second inclined mirror portion 115 may be formed with a plurality of reflective faces.

FIG. 3 illustrates an example of the large capacity optical fiber 1000 according to the first embodiment of the present invention. The optical fiber 1000 includes the plurality of concentrically disposed core portions 1010-1, . . . , 1010-7. In the illustrated example, the plurality of core portions 1010-1, . . . , 1010-7 are extended in a longitudinal direction. While the illustrated example has seven cores, the number of cores may be 19, as will be described later. The positional relationship of the core portions 1010-1, . . . , 1010-7 will be described in detail later with reference to FIG. 6.

FIG. 4 illustrates an example of the array optical element unit 3000 according to the first embodiment of the present invention. The array optical element unit 3000 may be adapted to the present invention both as a light receiving element and a light emitting element. The array optical element unit 3000 according to the present invention includes a plurality of elements (incident portions or emitting portions) 3010-1, . . . , 3010-7 on which a plurality of optical signals are incident or that emit a plurality of optical signals. The plurality of elements 3010-1, . . . , 3010-7 are generally linearly disposed. Here, the array optical element unit 3000 is a general-purpose, linear array-type optical device.

As described above, the array optical element unit 3000 may be a light receiving element or a light emitting element. For example, when the array optical element unit 3000 is a light receiving element, the plurality of optical signals emitted from the plurality of core portions 1010-1, . . . , 1010-7 have their optical paths converted by the optical path conversion unit 100, and the plurality of optical signals from the optical path conversion unit 100 are received by the array optical element unit 3000. On the other hand, when the array optical element unit 3000 is a light emitting element, the plurality of optical signals from the array optical element unit 3000 become incident on the optical path conversion unit 100, the plurality of optical signals have their optical paths converted by the optical path conversion unit 100, and the optical signals from the optical path conversion unit 100 become incident on the plurality of core portions 1010-1, . . . , 1010-7.

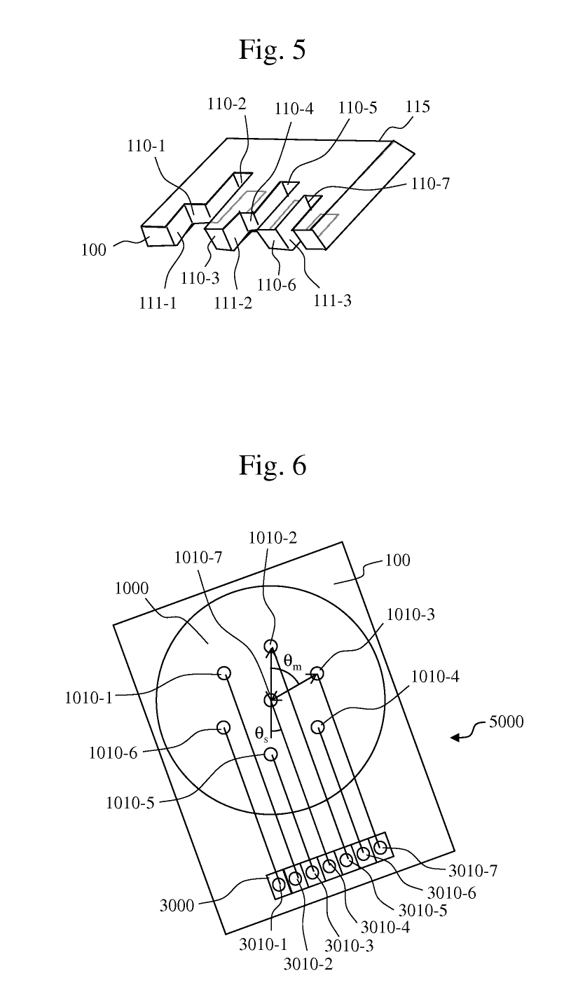

FIG. 5 illustrates another example of the optical path conversion unit 100 according to the first embodiment of the present invention. In the example of FIG. 2, the plurality of first inclined mirror portions 110-1, . . . , 110-7 of the optical path conversion unit 100 are fabricated from V-shaped groove shaped portions. In the example of FIG. 5, the plurality of first inclined mirror portions 110-1, . . . , 110-7 are fabricated from cut-out portions. In FIG. 5, in the optical path conversion unit 100, a plurality of cut-out portions 111-1, . . . , 111-3 are fabricated, and faces formed by the cut-out portions 111-1, . . . , 111-3 provide the plurality of first inclined mirror portions 110-1, . . . , 110-7. The cut-out portions 111-1, . . . , 111-3 are formed such that the plurality of first inclined mirror portions 110-1, . . . , 110-7 are concentrically disposed corresponding to the positions of the plurality of core portions 1010-1, . . . , 1010-7.

Thus, for the optical path conversion of the optical signals, the relative positional relationship between the first inclined mirror portions 110-1, . . . , 110-7 and the plurality of core portions 1010-1, . . . , 1010-7 is important. The plurality of first inclined mirror portions 110-1, . . . , 110-7 may include at least the concentrically disposed reflective faces corresponding to the positions of the plurality of core portions 1010-1, . . . , 1010-7. Accordingly, the shape of the optical path conversion unit 100 other than the portions (reflective faces) on which the optical signals are actually reflected at the first inclined mirror portions 110-1, . . . , 110-7 may be fabricated as desired. When the material of the optical path conversion unit 100 is resin or glass with a low melting point, a mold may be used for manufacture. Thus, by using a mold formed with the V-shaped groove shaped portions shown in FIG. 2 or the cut-out portions shown in FIG. 5, the optical path conversion unit 100 can be easily manufactured.

In the example of FIG. 5 too, the second inclined mirror portion 115 is formed on the face of the optical path conversion unit 100 corresponding to the optical paths of the optical signals reflected by the first inclined mirror portions 110-1, . . . , 110-7 (or the optical signals reflected toward the first inclined mirror portions 110-1, . . . , 110-7). It is preferable that the plurality of first inclined mirror portions 110-1, . . . , 110-7 and the inclined mirror portion 115 of the optical path conversion unit 100 have high reflectivity for efficiency. Thus, the first and the second inclined mirror portions 110-1, . . . , 110-7 and 115 may be coated with metal (such as aluminum or gold), or a dielectric multilayer film. In the optical path conversion unit 100 of FIG. 2 and the optical path conversion unit 100 of FIG. 5, the optical paths of the optical signals are the same. Accordingly, the following description will be made with reference to the optical path conversion unit 100 of FIG. 5 with a simpler perspective view, cross sectional view, and the like.

FIG. 6 is a top view of the optical module 5000 according to the first embodiment of the present invention. In the optical fiber 1000 which is a multi-core fiber, it is preferable to make the intervals between the geometrically adjacent core portions 1010-1, . . . , 1010-7 uniform so that optical crosstalk during transmission of optical signals using the core portions 1010-1, . . . , 1010-7 can be equally suppressed. In order to satisfy this condition, when there are the seven core portions 1010-1, . . . , 1010-7, for example, the core portions 1010-1, . . . , 1010-6 are disposed in a regular hexagon with the core portion 1010-7 disposed at the center of the regular hexagon. In this arrangement, the three adjacent core portions 1010-2, 1010-3, and 1010-7 form a regular triangle, with θm of 60° in FIG. 6.

A method of realizing optical path conversion will be described in detail in the following. Herein, an example will be described in which the array optical element unit 3000 is a light receiving element. In this example, a plurality of optical signals emitted from the plurality of core portions 1010-1, . . . , 1010-7 have their optical paths converted by the optical path conversion unit 100, and the plurality of optical signals from the optical path conversion unit 100 are received by the elements 3010-1, . . . , 3010-7 of the array optical element unit 3000. In order to draw an optical signal to the array optical element unit 3000 when the optical fiber 1000 is viewed from the upper surface thereof, one easy way is to draw the optical signal linearly diagonally while avoiding the other core portions. The angle θs for such diagonal drawing is approximately 20° in the case of seven cores. Herein, the angle θs is approximately 20° in order to allow the plurality of optical signals to be reflected such that the optical paths of the plurality of optical signals are parallel to each other. However, from the viewpoint of suppressing optical crosstalk, it is only necessary that the optical paths of the plurality of optical signals be not intersecting with each other. Accordingly, the diagonally drawing angle θs is not limited to approximately 20°, and the angle may be set in a range such that the optical paths of the plurality of optical signals do not intersect with each other.

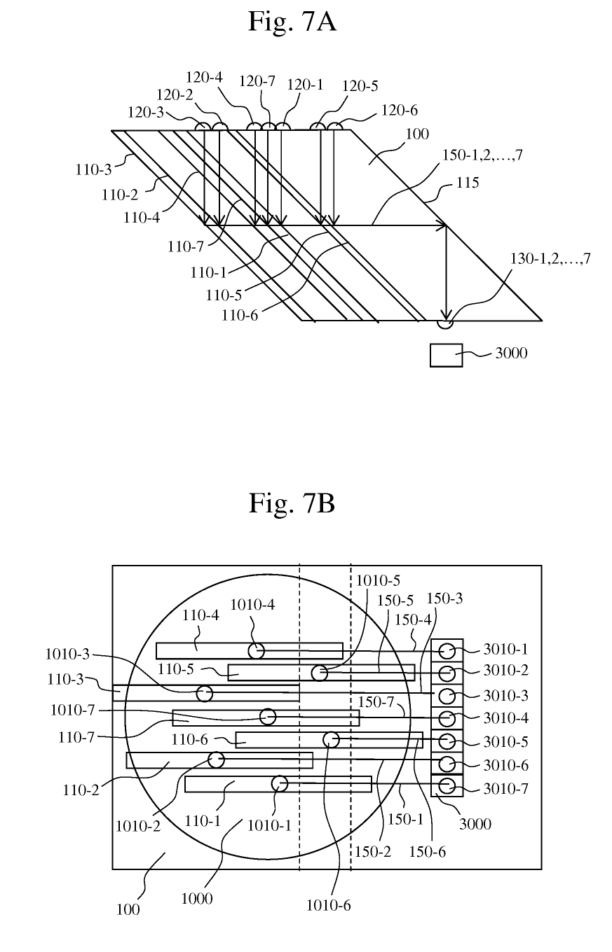

FIG. 7A is a side view of the optical path conversion unit and the array optical element unit according to the first embodiment of the present invention. FIG. 7B is a top view of the optical path conversion unit and the array optical element unit according to the first embodiment of the present invention. In the top view of FIG. 7B, the first inclined mirror portions 110-1, . . . , 110-7 are depicted as rectangles in a simplified manner.

As illustrated in FIG. 7A, the optical signals emitted from the plurality of core portions 1010-1, . . . , 1010-7 of the optical fiber 1000 are condensed by a plurality of first lens portions 120-1, . . . , 120-7 disposed on the upper surface of the optical path conversion unit 100. The condensed optical signals are reflected by the first inclined mirror portions 110-1, . . . , 110-7 of the optical path conversion unit 100 at a right angle to be nearly at the same height as viewed laterally.

Such optical path conversion can be realized by disposing the first inclined mirror portions 110-1, . . . , 110-7 nearly just below the respective core portions 1010-1, . . . , 1010-7 of the optical fiber 1000, as illustrated in FIG. 7B. Specifically, as described above, the reflective faces of the plurality of first inclined mirror portions 110-1, . . . , 110-7 are concentrically disposed corresponding to the positions of the plurality of core portions 1010-1, . . . , 1010-7. The first inclined mirror portions 110-1, . . . , 110-7 reflect the plurality of optical signals emitted from the plurality of core portions 1010-1, . . . , 1010-7 in such a manner that the optical paths 150-1, . . . , 150-7 of the plurality of optical signals do not intersect with each other. In the present embodiment, the first inclined mirror portions 110-1, . . . , 110-7 reflect the plurality of optical signals at the same height as viewed laterally, and reflect the plurality of optical signals diagonally and almost parallel with each other as viewed from the upper surface. The plurality of optical signals drawn in this manner are reflected by the second inclined mirror portion 115 downward and such that the optical paths of the plurality of optical signals become nearly parallel with each other. In this example, the plurality of optical signals have their optical paths converted by the second inclined mirror portion 115 nearly directly downward and at a right angle. The optical signals are condensed by second lens portions 130-1, . . . , 130-7 and become incident on the respective elements 3010-1, . . . , 3010-7 (in this case, the incident portions) of the array optical element unit 3000. When the array optical element unit 3000 is a light emitting element, the optical paths are inversely traced. By the above configuration, the optical path conversion unit 100 for achieving optical coupling of the optical fiber 1000 and the array optical element unit 3000 can be provided.

In the present embodiment, the first inclined mirror portions 110-1, . . . , 110-7 reflect the plurality of optical signals at the same height and nearly at a right angle as viewed laterally, and such that the optical paths 150-1, . . . , 150-7 of the plurality of optical signals become almost parallel with each other as viewed from the upper surface. However, the present invention is not limited to such configuration. The reflecting positions (height) by the first inclined mirror portions 110-1, . . . , 110-7 may be different, at least as long as the optical paths of the plurality of optical signals do not intersect with each other. It is only required that the optical signals reflected by the second inclined mirror portion 115 eventually become incident on the elements 3010-1, . . . , 3010-7 of the array optical element unit 3000. Thus, in accordance with the reflecting positions (heights) or reflecting directions of the first inclined mirror portions 110-1, . . . , 110-7, the second inclined mirror portion 115 may be provided with a plurality of reflective faces having different heights or angles. According to the present embodiment, the plurality of optical signals are reflected at the same height as viewed laterally and such that the optical paths of the plurality of optical signals become almost parallel with each other. This provides the advantage that the second inclined mirror portion 115 can be formed as a single reflective face.

According to the present embodiment, there can be provided the optical path conversion unit 100 (optical path converting optical coupling device) that does not require a custom layout with respect to the optical connection of an MCF (optical fiber 1000) with a general-purpose number of cores (such as seven or 19) and a general-purpose optical device (such as the linear array-type array optical element unit 3000). Accordingly, optical connection of the MCF and the general-purpose linear array-type optical device can be easily realized with low loss and in a small size.

Particularly, according to the conventional technology such as Patent Literature 1, the general-purpose MCF with concentrically disposed cores is not used, and the optical fiber itself is disposed on the optical path conversion device at an angle, for example, resulting in the need for a custom layout. Thus, the technology according to Patent Literature 1 leads to a large-sized optical module and a costly structure.

Further, in Patent Literature 1, because the optical fiber itself is disposed on the optical path conversion device in an inclined manner, optical fiber alignment and the like are difficult. In contrast, according to the present embodiment, as illustrated in FIG. 1, the optical fiber 1000 is configured to be placed on the plane surface 5001 of the optical module 5000. Thus, optical fiber alignment can be made with the optical fiber 1000 placed on the plane surface 5001, and, advantageously, optical fiber alignment is easy compared with the conventional example.

### Second Embodiment

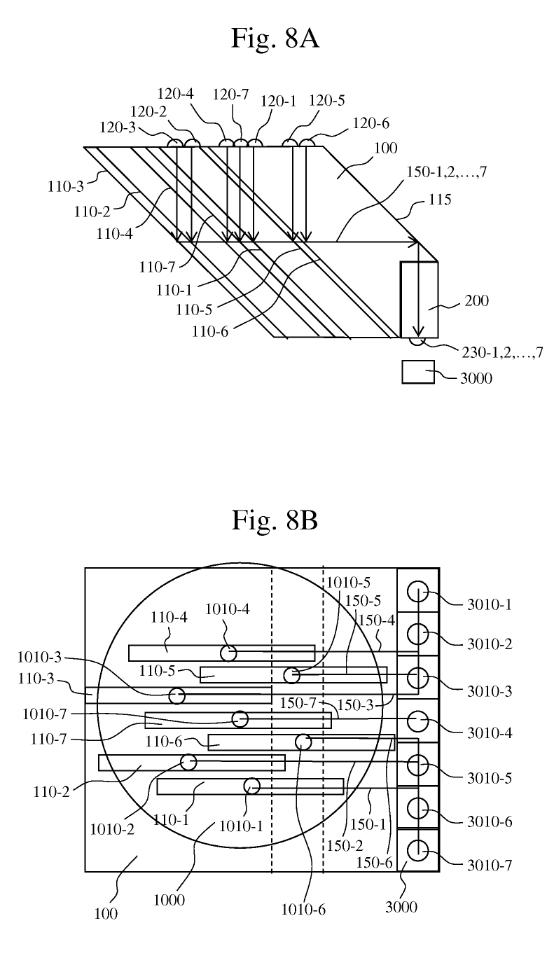

In the present embodiment, when the pitch intervals of the elements (incident portions or emitting portions) 3010-1, . . . , 3010-7 of the array optical element unit 3000 are greater than the intervals of the light rays diagonally drawn from the core portions 1010-1, . . . , 1010-7 of the optical fiber 1000, the pitch intervals of the optical paths of the optical signals are increased. Hereafter, the present embodiment will be described with reference to FIG. 8A to FIG. 10. Herein, an example in which the array optical element unit 3000 is a light receiving element will be described.

FIG. 8A is a side view of the optical path conversion unit and the array optical element unit according to the second embodiment. FIG. 8B is a top view of the optical path conversion unit and the array optical element unit according to the second embodiment. In the top view of FIG. 8B, the first inclined mirror portions 110-1, . . . , 110-7 are depicted by rectangles in a simplified manner.

In FIG. 8B, the pitch intervals of the elements (here, the incident portions) 3010-1, . . . , 3010-7 of the array optical element unit 3000 are greater than the intervals of the optical paths 150-1, . . . , 150-7 of the optical signals diagonally drawn from the core portions 1010-1, . . . , 1010-7 of the optical fiber 1000. In this case, as illustrated in FIG. 8A, the optical path conversion unit 100 includes a second optical path conversion unit 200. The second optical path conversion unit 200 modifies the intervals of the optical paths of the plurality of optical signals reflected by the second inclined mirror portion 115 so as to cause the plurality of optical signals to become incident on the respective elements 3010-1, . . . , 3010-7 of the array optical element unit 3000.

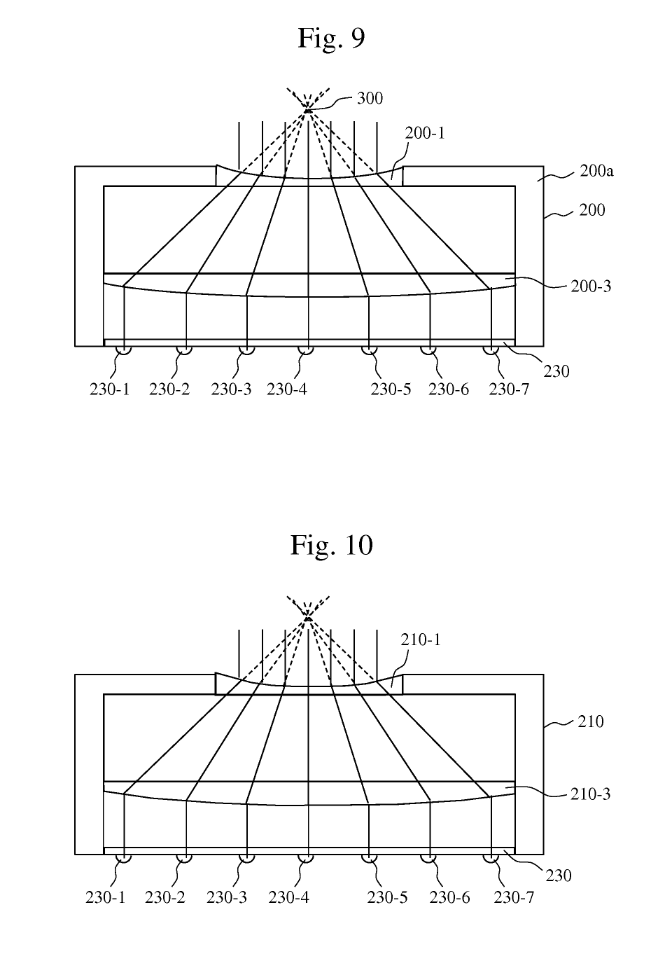

The optical signals emitted from the plurality of core portions 1010-1, . . . , 1010-7 of the optical fiber 1000 are condensed by the plurality of first lens portions 120-1, . . . , 120-7 disposed on the upper surface of the optical path conversion unit 100, reflected by the first inclined mirror portions 110-1, . . . , 110-7, and further reflected downward by the second inclined mirror portion 115, as in the first embodiment. Thus, redundant description will be omitted. A configuration for modifying the pitch intervals of the optical paths of the optical signals using the second optical path conversion unit 200 will be described with reference to FIG. 9.

FIG. 9 is a cross sectional view of the second optical path conversion unit. The second optical path conversion unit 200 includes a concave lens portion 200-1, a convex lens portion 200-3, and a lens portion 230. The concave lens portion 200-1 and the convex lens portion 200-3 are supported by a frame member 200a. Here, the focal point position of the convex lens portion 200-3 and the focal point position of the concave lens portion 200-1 are the same (a focal point 300). The condensing lens portion 230 includes a plurality of lens portions 230-1, . . . , 230-7.

The optical signals caused to descend nearly parallel to each other and directly downward by the second inclined mirror portion 115 of the optical path conversion unit 100 are caused by the concave lens portion 200-1 to travel in a spreading manner. Next, while the optical signals are made narrower by the convex lens portion 200-3, because the focal point position of the convex lens portion 200-3 and the focal point position of the concave lens portion 200-1 are the same (the focal point 300), the emitted optical signals travel nearly parallel to each other and directly downward.

Thereafter, the optical signals that have passed through the convex lens portion 200-3 are narrowed by the lens portions 230-1, . . . , 230-7 and caused to become incident on the respective elements 3010-1, . . . , 3010-7 of the array optical element unit 3000. When the array optical element unit 3000 is a light emitting element, the above-described optical paths are inversely traced. With respect to the depth direction in the figure, there is no need to expand the beams. Thus, the concave lens portion 200-1 and the convex lens portion 200-3 may employ cylindrical lenses.

FIG. 10 is a cross sectional view of another example of the second optical path conversion unit according to the second embodiment of the present invention. In this example, the second optical path conversion unit 210 includes a first prism portion 210-1 having a polygonal shape and a second prism portion 220-3 having a polygonal shape. In this example, the first prism portion 210-1 increases the intervals of the optical paths of the plurality of optical signals, and the second prism portion 220-3 makes the optical paths of the plurality of optical signals nearly parallel with each other. Specifically, as illustrated in FIG. 10, the optical signals caused by the second inclined mirror portion 115 of the optical path conversion unit 100 to descend nearly parallel to each other and directly downward are caused by the first prism portion 210-1 to travel in a spreading manner. Then, the optical signals are caused by the second prism portion 220-3 to travel nearly parallel to each other and directly downward. In this example, instead of the concave lens portion 200-1 and the convex lens portion 200-3, the first prism portion 210-1 and the second prism portion 220-3 can be used to eliminate the influence of an increase or decrease in the width of the beams of the optical signals themselves due to a lens.

Any configuration may be used as long as the optical paths of the optical signals can be expanded and then the optical signals can be caused to travel nearly parallel to each other. Thus, the second optical path conversion unit 200 may be configured using other members, such as a diffraction grating or a mirror. In the above-described embodiment, the concave lens portion 200-1 and the convex lens portion 200-3 are supported by the frame member 200a. Alternatively, instead of using the frame member 200a, the second optical path conversion unit 200 or 210 and the like may be integrally formed by cutting out a part of the optical path conversion unit 100.

According to the present embodiment, even when the pitch intervals of the elements (the incident portions or emitting portion) 3010-1, . . . , 3010-7 of the array optical element unit 3000 are greater than the intervals of the optical paths 150-1, . . . , 150-7 of the optical signals diagonally drawn from the core portions 1010-1, . . . , 1010-7 of the optical fiber 1000, optical coupling of the optical fiber 1000 and the array optical element unit 3000 can be made. Further, according to the present embodiment, the plurality of first inclined mirror portions 110-1, . . . , 110-7 have the same reflective face angle setting, and the second inclined mirror portion 115 can also be configured as a single reflective face. Thus, an advantage is obtained that the configuration of the first inclined mirror portions 110-1, . . . , 110-7 and the second inclined mirror portion 115 can be simplified.

### Third Embodiment

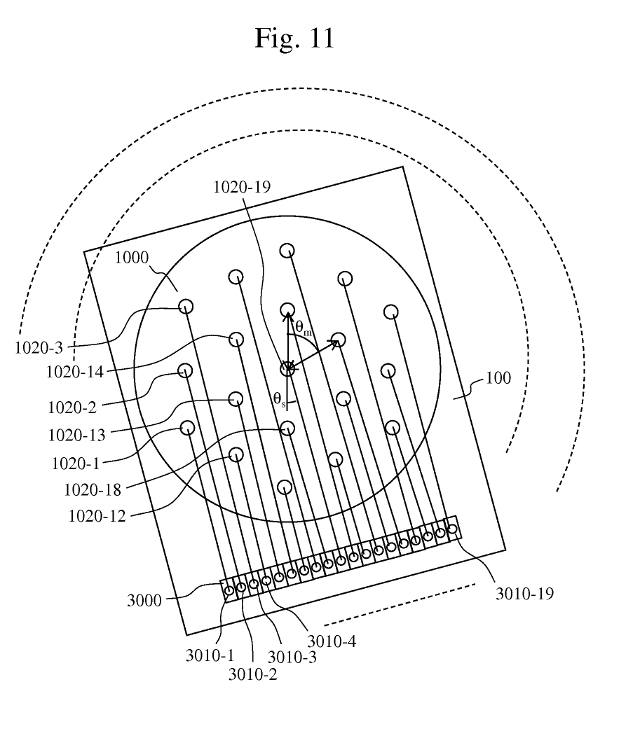

FIG. 11 is a top view of an optical module according to a third embodiment of the present invention, which optical module is applied to the large capacity optical fiber 1000 where the number of cores is 19.

In a multi-core fiber, as described above, it is preferable to make the intervals between geometrically adjacent core portions 1020-1, . . . , 1020-19 uniform so as to equally suppress optical crosstalk during transmission of the optical signals using the core portions 1020-1, . . . , 1020-19. In order to satisfy this condition, when there are 19 core portions 1020-1, . . . , 1020-19, for example, six core portions are disposed on a regular hexagon, and 12 core portions are disposed on a regular dodecagon of the same length as the sides of the regular hexagon, and the core portion 1020-19 is disposed such that the regular hexagon and the regular dodecagon are concentric. The distance between the core portion 1020-19 and the core portion 1020-13, and the distance between the core portion 1020-13 and the core portion 1020-1 are equal to the length of the sides of the regular hexagon (on the regular dodecagon). Any three adjacent core portions form a regular triangle. Thus, θm is 60° in FIG. 11.

As in the case of the seven cores illustrated in FIG. 6, in order to draw an optical signal to the array optical element unit 3000 when the large capacity optical fiber 1000 is viewed from the upper surface, a simple way is to linearly diagonally draw the optical signal while avoiding the other core portions. The angle θs for such diagonal drawing is approximately 12° in the case of 19 cores.

According to the present embodiment, 19 first inclined mirror portions are concentrically disposed corresponding to the positions of the 19 core portions 1020-1, . . . , 1020-19. Here, in order for the 19 first inclined mirror portions to reflect the plurality of optical signals in such a way that the optical paths of the plurality of optical signals are nearly parallel with each other, the angle θs is set to be approximately 12°. However, from the viewpoint of suppressing optical crosstalk, it is only required that the optical paths of the plurality of optical signals do not intersect with each other. Accordingly, the diagonally drawing angle θs is not limited to approximately 12°, and the angle may be set in a range such that the optical paths of the plurality of optical signals do not intersect with each other.

Thus, the angle θs for diagonally drawing from the central axis of the large capacity optical fiber 1000 as viewed from the upper surface is set in accordance with the number of cores, and the optical signals are drawn such that the optical paths of the plurality of optical signals do not intersect each other. In this way, optical coupling of the large capacity optical fiber 1000 where the number of cores is 19 and the array optical element unit 3000 can be made.

### Fourth Embodiment

The present embodiment is another example of the embodiment where, when the pitch intervals of the elements (incident portions or emitting portions) 3010-1, . . . , 3010-7 of the array optical element unit 3000 are greater than the intervals of the optical paths of the optical signals diagonally drawn from the core portions 1010-1, . . . , 1010-7 of the optical fiber 1000, the pitch intervals of the optical paths of the optical signals are increased. Here, an example will be described in which the array optical element unit 3000 is a light receiving element.

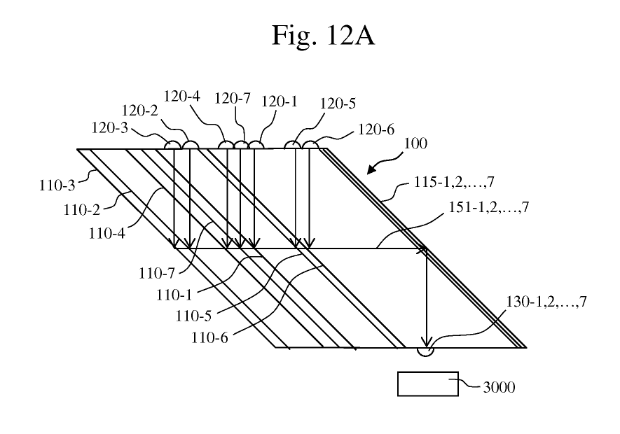

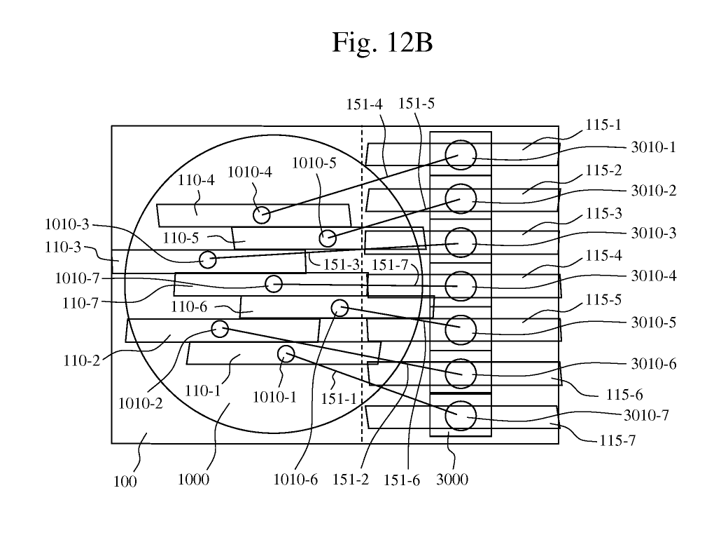

FIG. 12A is a side view of the optical path conversion unit and the array optical element unit according to a fourth embodiment. FIG. 12B is a top view of the optical path conversion unit and the array optical element unit according to the fourth embodiment. In this embodiment, the optical path conversion unit 100 includes the plurality of first inclined mirror portions 110-1, . . . , 110-7, and a plurality of second inclined mirror portions 115-1, . . . , 115-7 corresponding to the plurality of first inclined mirror portions 110-1, . . . , 110-7. In this example, the drawing of the optical signals diagonally and nearly parallel to each other from the optical fiber 1000 as viewed from the upper surface is not performed. Instead, in this configuration, the optical signals are caused to become incident on the elements (here, incident portions) 3010-1, . . . , 3010-7 of the array optical element unit 3000 by providing the plurality of second inclined mirror portions 115-1, . . . , 115-7 paired with the first inclined mirror portions 110-1, . . . , 110-7.

As illustrated in FIG. 12B, the plurality of second inclined mirror portions 115-1, . . . , 115-7 are disposed side by side corresponding to the positions of the elements 3010-1, . . . , 3010-7 of the array optical element unit 3000. The optical signals emitted from the optical fiber 1000 are condensed by the plurality of first lens portions 120-1, . . . , 120-7 disposed on the upper surface of the optical path conversion unit 100 and caused to enter the optical path conversion unit 100. The optical signals are reflected by the first inclined mirror portions 110-1, . . . , 110-7 of the optical path conversion unit 100 in such a way as to have nearly the same height as viewed laterally. Such optical path conversion can be realized by disposing the first inclined mirror portions 110-1, . . . , 110-7 approximately just below the core portions 1010-1, . . . , 1010-7 of the optical fiber 1000, as illustrated in FIG. 12.

In this example, the plurality of first inclined mirror portions 110-1, . . . , 110-7 have different angles as viewed from the upper surface. For example, as illustrated in FIG. 12B, because the first inclined mirror portion 110-7 reflects toward the second inclined mirror portion 115-7 at the center among the second inclined mirror portions 115-1, . . . , 115-7, the angle for diagonally drawing the optical signal is set to be small compared with the others. Also, because the first inclined mirror portion 110-4 reflects toward the second inclined mirror portion 115-4 disposed to the most outside among the second inclined mirror portions 115-1, . . . , 115-7, the angle for diagonally drawing the optical signal is set to be greater than in the case of the first inclined mirror portion 110-7. Thus, the respective angles of the reflective faces of the plurality of first inclined mirror portions 110-1, . . . , 110-7 are set in accordance with the positions of the corresponding second inclined mirror portions 115-1, . . . , 115-7. By using such setting, the plurality of first inclined mirror portions 110-1, . . . , 110-7 can reflect toward the plurality of second inclined mirror portions 115-1, . . . , 115-7 by increasing the intervals of the optical paths 150-1, . . . , 150-7 of the reflected optical signals as viewed from the upper surface.

The plurality of first inclined mirror portions 110-1, . . . , 110-7 are configured to reflect at the same height as viewed laterally. The optical signals drawn at the same height as viewed laterally and in a spreading direction as viewed from the upper surface have their optical paths converted by the plurality of second inclined mirror portions 115-1, . . . , 115-7 nearly directly downward. Specifically, the plurality of second inclined mirror portions 115-1, . . . , 115-7 reflect the plurality of optical signals reflected by the plurality of first inclined mirror portions 110-1, . . . , 110-7 such that the optical paths of the plurality of optical signals become parallel with each other, causing the optical signals to become incident on the respective elements of the array optical element. Such optical path conversion can be realized by providing the respective reflective faces of the plurality of second inclined mirror portions 115-1, . . . , 115-7 with different angles as viewed from the upper surface. The optical signals reflected by the plurality of second inclined mirror portions 115-1, . . . , 115-7 are condensed by the second lens portions 130-1, . . . , 130-7 and then become incident on the elements 3010-1, . . . , 3010-7 of the array optical element unit 3000. When the array optical element unit 3000 is a light emitting element, the above-described optical paths are inversely traced.

According to the present embodiment, when the pitch intervals of the elements (incident portions or emitting portions) 3010-1, . . . , 3010-7 of the array optical element unit 3000 are greater than the intervals of the optical paths of the optical signals diagonally drawn from the core portions 1010-1, . . . , 1010-7 of the optical fiber 1000, the optical fiber 1000 and the array optical element unit 3000 can be optically coupled without using separate members, such as the concave lens portion 200-1 and the convex lens portion 200-3, as according to the second embodiment. When such separate members are used to increase the intervals of the optical paths of the optical signals, it is necessary to consider the influence of the thermal expansion rate of each material, for example. However, in the present embodiment, there is no need to consider such influence.

### Fifth Embodiment

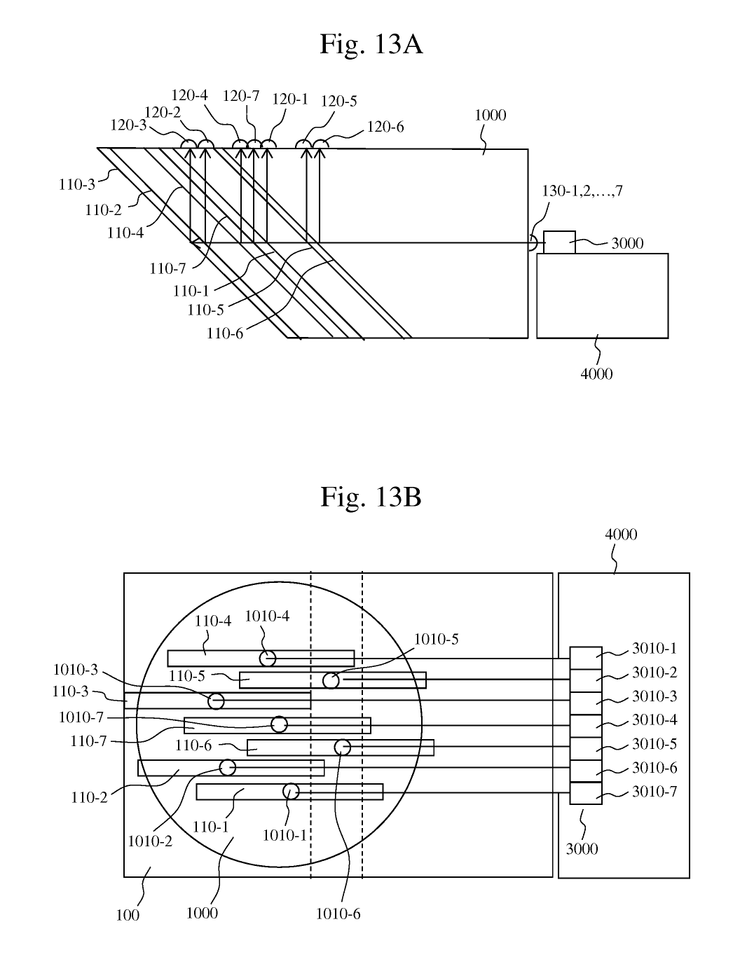

In the present embodiment, an example where the array optical element unit 3000 is a light emitting element will be described. For example, the array optical element unit 3000 is an edge emitter bonded onto the substrate 4000 by soldering and the like. FIG. 13A is a side view of the optical path conversion unit and the array optical element unit according to a fifth embodiment. FIG. 13B is a top view of the optical path conversion unit and the array optical element unit according to the fifth embodiment. In the top view of FIG. 13B, the first inclined mirror portions 110-1, . . . , 110-7 are depicted by rectangles in a simplified manner.

According to the present embodiment, the optical signals emitted from the elements (herein, emitting portions) 3010-1, . . . , 3010-7 of the array optical element unit 3000 are condensed by the second lens portions 130-1, . . . , 130-7 and caused to travel in a nearly lateral direction as viewed laterally. Thereafter, the plurality of optical signals are reflected by the plurality of first inclined mirror portions 110-1, . . . , 110-7. The plurality of optical signals reflected by the plurality of first inclined mirror portions 110-1, . . . , 110-7 travel nearly directly upward and in such a way that the optical paths of the plurality of optical signals become nearly parallel with each other. The plurality of optical signals are then condensed by the plurality of first lens portions 120-1, . . . , 120-7 and become incident on the plurality of core portions 1010-1, . . . , 1010-7 of the optical fiber 1000.

According to the present embodiment, even when the elements 3010-1, . . . , 3010-7 of the array optical elements unit 3000 are incident portions of the edge emitter, the optical fiber 1000 and the array optical element unit 3000 can be optically coupled.

### Sixth Embodiment

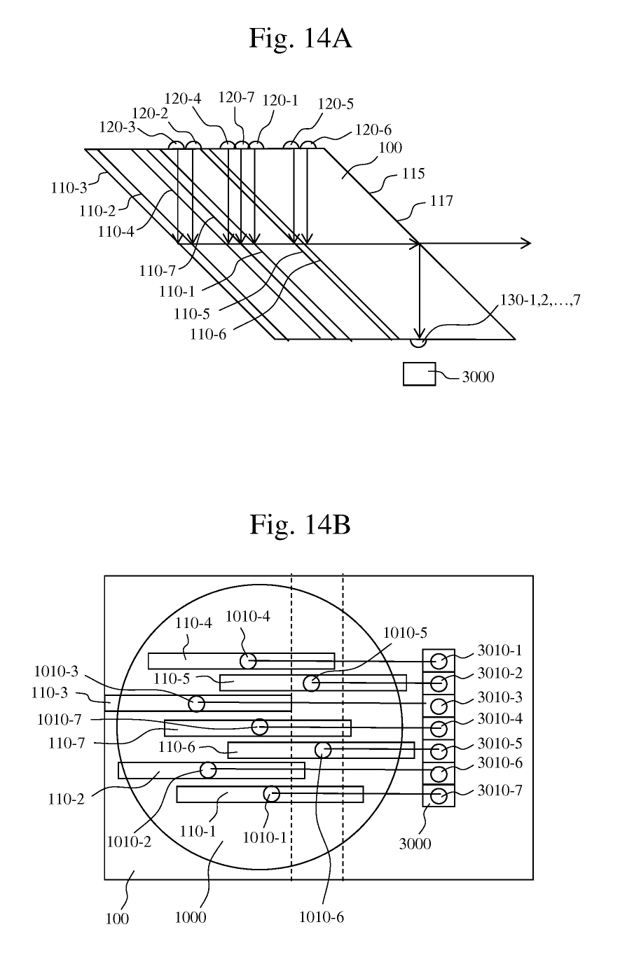

FIG. 14A is a side view of the optical path conversion unit and the array optical element unit according to a sixth embodiment. FIG. 14B is a top view of the optical path conversion unit and the array optical element unit according to the sixth embodiment. In the top view of FIG. 14B, the first inclined mirror portions 110-1, . . . , 110-7 are depicted by rectangles in a simplified manner. Herein, an example will be described in which the array optical element unit 3000 is a light receiving element.

According to the present embodiment, the second inclined mirror portion 115 of the optical path conversion unit 100 includes an optical path branching portion 117 that branches each of the plurality of optical signals into two directions. For example, the optical path branching portion 117 includes an inclined half mirror portion that branches the optical signal into two. One optical signal is made incident on the array optical element unit 3000 as a main signal, and the other optical signal is processed as an optical power monitoring signal, for example. For the optical path branching portion 117, a partially transmissive mirror with appropriately modified transmissivity may be used, whereby the optical signal can be transmitted and allowed to travel straight ahead while being reflected. The optical path branching portion 117 may be realized by other configurations, including the use of a mirror, as long as the optical signal can be branched in two directions.

The optical signals emitted from the optical fiber 1000 are condensed by the first lens portion 120-1, . . . , 120-7 disposed on the upper surface of the optical path conversion unit 100 and then enter the optical path conversion unit 100. The optical signals are reflected by the plurality of first inclined mirror portions 110-1, . . . , 110-7 of the optical path conversion unit 100 at a right angle such that the optical signals are substantially at the same height as viewed laterally. Such optical path conversion can be realized by disposing the plurality of first inclined mirror portions 110-1, . . . , 110-7 nearly just below the core portions 1010-1, . . . , 1010-7 of the optical fiber 1000, as described with reference to FIG. 14A. The optical signals drawn at the same height as viewed laterally and almost parallel to each other diagonally as viewed from the upper surface are branched by the optical path branching portion 117 of the second inclined mirror portion 115. One of the branched optical signals becomes incident on the array optical element unit 3000 as a main signal. The other optical signal travels in a lateral direction and may be processed as an optical power monitoring signal, for example.

The present invention is not limited to the foregoing embodiments and may include various modifications. The foregoing embodiments have been described in detail for facilitating an understanding of the present invention, and are not limited to include all of the described constituent elements. Some of the constituent elements of one embodiment may be substituted by constituent elements of another embodiment, or an element of the other embodiment may be incorporated into the one embodiment. With respect to some of the constituent elements of each embodiment, addition, deletion, or substitution of other constituent elements may be made.

### REFERENCE SIGNS LIST

100 Optical path conversion unit
110-1, . . . , 110-7 First inclined mirror portion
111-1, . . . , 111-3 Cut-out portion
115 Second inclined mirror portion
115-1, . . . , 115-7 Second inclined mirror portion
117 Optical path branching portion
200 Second optical path conversion unit
210 Second optical path conversion unit
1000 Large capacity optical fiber
1010-1, . . . , 1010-7 Core portion
1020-1, . . . , 1020-19 Core portion
3000 Array optical element unit
3010-1, . . . , 3010-7 Element
5000 Optical module

1. An optical path converting optical coupling device for an optical fiber having a plurality of concentrically disposed cores, the device comprising
a plurality of first inclined mirror portions concentrically disposed corresponding to positions of the plurality of cores,
wherein the plurality of first inclined mirror portions reflect a plurality of optical signals emitted from the plurality of cores or becoming incident on the plurality of cores, in such a manner that optical paths of the plurality of optical signals do not intersect with each other.

2. The optical path converting optical coupling device according to claim 1, further comprising one or more second inclined mirror portions that reflect the plurality of optical signals reflected by the plurality of first inclined mirror portions.

3. The optical path converting optical coupling device according to claim 2, further comprising an optical path conversion unit that modifies intervals of the optical paths of the plurality of optical signals reflected by the second inclined mirror portion.

4. The optical path converting optical coupling device according to claim 3, wherein the optical path conversion unit includes a concave lens and a convex lens, and the concave lens and the convex lens have the same focal point position.

5. The optical path converting optical coupling device according to claim 3, wherein the optical path conversion unit includes a first polygonal prism that increases the intervals of the optical paths of the plurality of optical signals, and a second polygonal prism that makes the optical paths of the plurality of optical signals parallel with each other.

6. The optical path converting optical coupling device according to claim 2, wherein:
a plurality of the second inclined mirror portions are disposed side by side;
the plurality of the first inclined mirror portions reflect the plurality of optical signals toward the plurality of the second inclined mirror portions disposed side by side; and
the second inclined mirror portions reflect the plurality of optical signals reflected by the plurality of the first inclined mirror portions in such a manner that the optical paths of the plurality of optical signals become parallel with each other.

7. The optical path converting optical coupling device according to claim 2, wherein the second inclined mirror portion includes an optical path branching portion that branches each of the plurality of optical signals in two directions.

8. An optical module comprising:
an optical fiber having a plurality of concentrically disposed cores;
an optical path converting optical coupling device that converts optical paths of a plurality of optical signals emitted from the plurality of cores of the optical fiber or becoming incident on the plurality of cores; and
an array optical element including a plurality of linearly disposed elements that receive the plurality of optical signals from the optical path converting optical coupling device or that emit the plurality of optical signals to the optical path converting optical coupling device,
wherein the optical path converting optical coupling device includes a plurality of first inclined mirror portions concentrically disposed corresponding to positions of the plurality of cores, and
wherein the plurality of the first inclined mirror portions reflect the plurality of optical signals emitted from the plurality of cores or from the array optical element, in such a manner that the optical paths of the plurality of optical signals do not intersect with each other.

9. The optical module according to claim 8, wherein the optical path converting optical coupling device further includes one or more second inclined mirror portions that reflect the plurality of optical signals reflected by the plurality of the first inclined mirror portions and that make the plurality of optical signals incident on the elements of the array optical element.

10. The optical module according to claim 9, wherein the optical path converting optical coupling device further includes an optical path conversion unit that modifies intervals of the optical paths of the plurality of optical signals reflected by the second inclined mirror portion so as to make the plurality of optical signals incident on the elements of the array optical element.

11. The optical module according to claim 10, wherein the optical path conversion unit includes a concave lens and a convex lens, and the concave lens and the convex lens have the same focal point position.

12. The optical module according to claim 10, wherein the optical path conversion unit further includes a first polygonal prism that increases the intervals of the optical paths of the plurality of optical signals, and a second polygonal prism that makes the optical paths of the plurality of optical signals parallel with each other.

13. The optical module according to claim 9, wherein:
a plurality of the second inclined mirror portions are disposed side by side corresponding to the positions of the elements of the array optical element;
the plurality of the first inclined mirror portions reflect the plurality of optical signals toward the plurality of the second inclined mirror portions disposed side by side; and
the second inclined mirror portions reflect the plurality of optical signals reflected by the plurality of the first inclined mirror portions in such a manner that the optical paths of the plurality of optical signals become parallel with each other and incident on the elements of the array optical element.

14. The optical module according to claim 9, wherein the second inclined mirror portion includes an optical path branching portion that branches each of the plurality of optical signals in two directions, wherein
one of the optical signals branched by the optical path branching portion becomes incident on each element of the array optical element.
